(19) United States
(12) Patent Application Publication
(10) Pub. No.: US 2015/0226346 A1
(43) Pub. Date: Aug. 13, 2015

(54) Piston-type one-way valve

(71) Applicant: Xiaohong DING, Nantong, Jiangsu (CN)

(72) Inventor: Xiaohong Ding, Nantong (CN)

(21) Appl. No.: 14/343,859

(22) PCT Filed: Jan. 8, 2014
(86) PCT No.: PCT/CN14/70339

§ 371 Date: Mar. 9, 2014

(30) Foreign Application Priority Data
Jan. 8, 2013 (CN) 201320008104.8

(51) Int. Cl. F16K 15/06

(52) U.S. Cl. CPC F16K 15/063

(57) ABSTRACT

A piston-type one-way valve, comprises: a valve body shell; and a valve cover, fixedly connected with said valve body shell via cover bolts; wherein said piston comprises: a piston head, and a sealing gasket; a cylinder convex is provided in a center of said valve cover; a piston rod sleeve is provided in said cylinder convex; said piston rod sleeve matches and sleeves said piston rod; a spring base is fixed at a first end of said piston rod sleeve; a first end of a spring is fixed on said spring base; a second end of said spring is fixed on said piston rod; and a ring-shaped element is provided along an opening edge of said cover, and fixedly connected with said opening edge of said cover; an inner circle of said ring-shaped element touches outer circles of said piston head or said sealing gasket closely.

### CROSS REFERENCE OF RELATED APPLICATION

This is a Continuation-In-Parts application of an International Application PCT/CN2014/070339, filed on Jan. 8, 2014, which claims the benefit of CN 201320008104.8 and priority date of Jan. 8, 2013.

### BACKGROUND OF THE PRESENT INVENTION

1. Field of Invention

The present invention relates to a pipeline controlling equipment, and more particularly to a piston-type one-way valve.

2. Description of Related Arts

The one-way valve is an important and indispensable part in the cooling equipment, which is installed at the air outlet of the compressor in the cooling equipment to prevent reversing of the compressor when the cooling equipment stops running, or prevent flowing of the refrigerant from a running compressor to a compressor not running. When the cooling equipment is working, the piston is moving back and forth because of the effect of differential pressure, in such a manner that the one-way valve is opened and closed. The opening and closing of the conventional one-way valve depends on the reciprocating sliding of the piston relative to the valve seat. The impurities in the medium will easily jam the gap between the piston and the valve seat, so that the piston will incline and misalign the valve seat after repeated usage, which decreases the reliability of the one-way valve. In addition, the cooling equipment will vibrate because of the pressure pulse during running, which causes not only the noise during running of the cooling equipment, but also the mechanical wear of the cooling equipment. Thus, the service life of the cooling equipment is shortened.

### SUMMARY OF THE PRESENT INVENTION

An object of the present invention is to provide a piston-type one-way valve, to overcome shortages of the conventional technology, absorb vibration, reduce noise, and extend the service life of the cooling equipment.

Accordingly, in order to accomplish the above objects, the present invention provides a piston-type one-way valve, comprising:

a valve body shell; and

a valve cover, fixedly connected with the valve body shell via cover bolts;

wherein a piston is provided in the valve body shell; a valve seat having a shape of cylinder is provided in the valve body shell; a first side of the valve seat is connected with a medium inlet; a bottom of the valve seat is fixedly connected with the valve body shell; an upper opening of the valve seat matches the piston;

a body chamber is defined by an outer wall of the valve seat and an inner wall of the valve body shell, which is connected with a medium outlet;

the piston comprises: a piston head, a piston rod fixedly connected with the piston head, and a sealing gasket fixed at a center of an end surface of the piston head through a piston bolt and an auxiliary fixing gasket; wherein a diameter of the upper opening of the valve seat is smaller than the diameter of sealing gasket, in such a manner that when the piston is pressed down, the sealing gasket touches the upper opening of valve seat to seal the body chamber and to further prevent medium in the body chamber from flowing back to a seat chamber in the valve seat when the piston-type one-way valve is working;

a cylinder convex is provided in a center of the valve cover; a piston rod sleeve in a shape of cylinder is provided in the cylinder convex; the piston rod sleeve matches and sleeves the piston rod; a round hole is provided in a center of an end surface of the piston rod for matching the piston rod with the piston rod sleeve and reduce a weight of the piston rod;

a spring base is fixed at a first end of the piston rod sleeve; a first end of a spring is fixed on the spring base; a second end of the spring is fixed on the piston rod; when the medium flows into the seat chamber from the medium inlet, the piston is pushed up by the medium and the spring is compressed; when the medium stops flowing into the seat chamber, the piston is tightly pressed upon the upper opening of the valve seat by the spring; and

a ring-shaped element is provided along an opening edge of the cover, and fixedly connected with the opening edge of the cover; an inner circle of the ring-shaped element touches outer circles of the piston head or the sealing gasket closely, in such a manner that a cover chamber is formed in the valve cover, which is disconnected with the body chamber, medium in the body chamber is not able to enter into the cover chamber, elements in the valve cover is protected from being polluted by the medium, and service lives of the elements are extended; and

an installing screw hole is provided in a bottom center of the valve body shell, for fixing the piston-type one-way valve on a cooling equipment.

Compared to the conventional technology, a piston-type one-way valve in the present invention has beneficial effects of:

1. reducing noise during running of a cooling equipment; and

2. extending a service life of the cooling equipment.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a piston-type one-way valve according to a preferred embodiment of the present invention.

FIG. 2 is a side view of the piston-type one-way valve according to the preferred embodiment of the present invention.

FIG. 3 is a top view of the piston-type one-way valve according to the preferred embodiment of the present invention.

valve body shell 1, valve cover 2, valve seat 3, medium inlet 4, body chamber 5-1, cover chamber 5-2, seat chamber 5-3, medium outlet 6, piston head 7, piston rod 8, sealing gasket 9, piston rod sleeve 10, spring base 11, spring 12, ring-shaped element 13, piston bolt 14-1, cover bolt 14-2, auxiliary fixing gasket 15, installing screw hole 16, round hole 17, elastic strip 18

### DETAILED DESCRIPTION OF THE PREFERRED EMBODIMENT

The substantial content of the present invention is described in detail as follows.

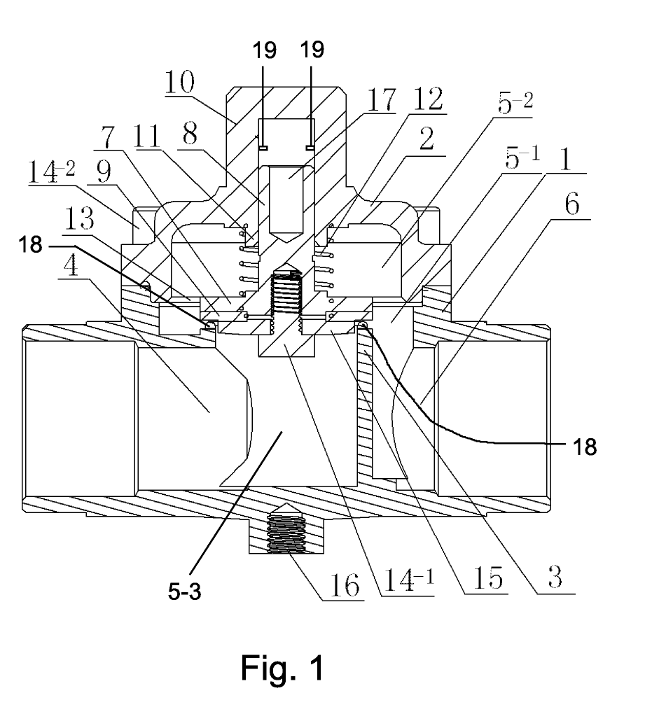

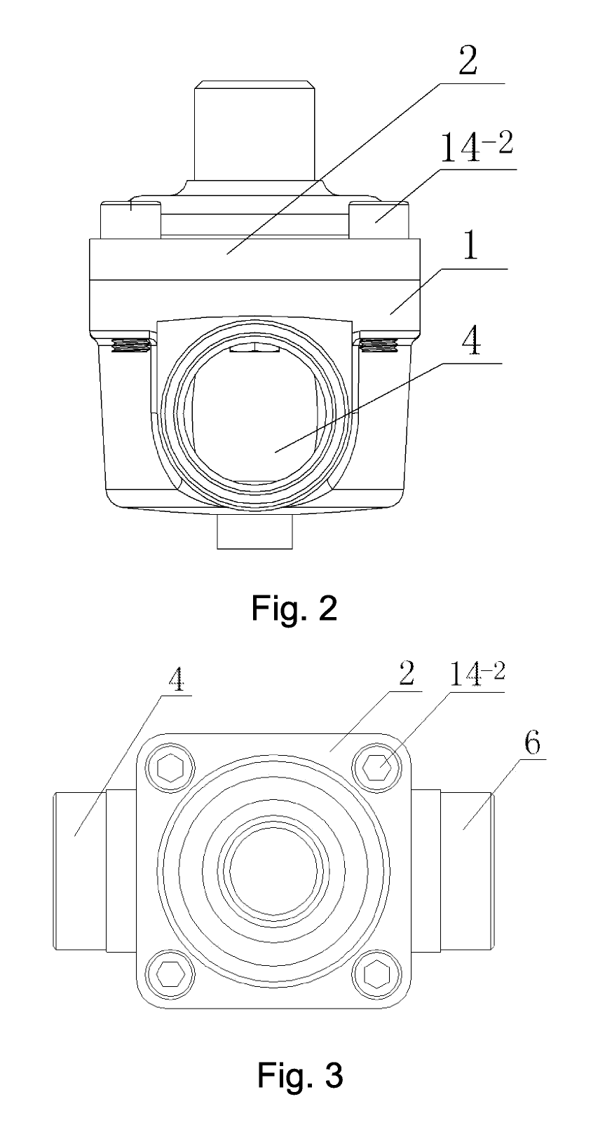

Referring to FIG. 1-3, a piston-type one-way valve comprises:

a valve body shell 1,

a valve cover 2, fixedly connected with the valve body shell 1 via cover bolts 14-2;

a valve seat 3, provided in the valve body shell 1, wherein the valve seat 3 is in a shape of cylinder, a first side of the valve seat 3 is connected with a medium inlet 4, a bottom of the valve seat 3 is fixedly connected with the valve body shell 1, a body chamber 5-1 is defined by an outer wall of the valve seat 3 and an inner wall of the valve body shell 1, which is connected with a medium outlet 6, and the valve seat 3 has an upper opening provided in an upper portion thereof;

a piston, provided in the valve body shell 1, comprising: a piston head 7, a piston rod 8 fixedly connected with the piston head 7, and a sealing gasket 9 fixed on an end surface of the piston head 7 through a piston bolt 14-1 and an auxiliary fixing gasket 15, wherein the sealing gasket 9 matches the upper opening of the valve seat 3 in shape, in such a manner that when the piston-type one-way valve is working and the piston is pressed down, the sealing gasket 9 completely covers the upper opening of the valve seat 3 to seal the body chamber 5-1 and to further prevent medium in the body chamber 5-1 from flowing back to a seat chamber 5-3 in the valve seat 5-3;

a cylinder convex, provided in a center of the valve cover 2, wherein a piston rod sleeve 10 in a shape of cylinder is provided in the cylinder convex, the piston rod sleeve 10 matches and sleeves the piston rod 8, and a round hole is provided in a center of an end surface of the piston rod for matching the piston rod 8 with the piston rod sleeve 10 and reducing a weight of the piston rod 8;

a spring base 11, fixed at a first end of the piston rod sleeve 10, wherein a first end of a spring 12 is fixed on the spring base 11, a second end of the spring 12 is fixed on the piston head 7, when the medium flows into the seat chamber 5-3 from the medium inlet 4, the piston is pushed up by the medium and the spring 12 is compressed, and when the medium stops flowing into the seat chamber 5-3, the piston is tightly pressed upon the upper opening of the valve seat 3 by the spring 12; and

a ring-shaped element 13, provided along an opening edge of the valve cover 2 and fixedly connected with the opening edge of the valve cove 2, wherein an inner circle of the ring-shaped element 13 touches an outer circle of the piston head 7 or the sealing gasket 9 closely, in such a manner that a cover chamber 5-2 is formed in the valve cover 2, which is disconnected with the body chamber 5-1, medium in the body chamber 5-1 is not able to enter into the cover chamber 5-2, elements in the valve cover 2 is protected from being polluted by the medium, and service lives of the elements are extended.

Preferably, a diameter of the upper opening of the valve seat 3 is smaller than a diameter of the sealing gasket 9, which means that when the piston is pressed down upon the upper opening of the valve seat 3, a part of the sealing gasket 9 is exposed to the body chamber 5-1, in such a manner that medium in the body chamber 5-1 of some pressure is able to push up the piston by applying a force on the part of the sealing gasket 9 exposed, and flow from the body chamber 5-1 to the seat chamber, which is for removing impurities sticking on the upper opening of the valve seat 3 or a surface of the sealing gasket 9.

Preferably, an elastic strip 18 is fixed on an edge of the upper opening of the valve seat 3, for deforming and touching the sealing gasket 9 closely when pressed by the piston.

Preferably, an upper surface of the elastic strip 18 is in a shape of arc bending downwards for preventing impurities in the medium staying on the upper surface of the elastic strip.

Preferably, an air hole is provided on the valve cover 2, for connecting the cover chamber 5-2 with outside, in such a manner that while the piston is going upwards, a part of air in the cover chamber 5-2 is going out of the valve cover 2 through the air hole. Therefore, a force for pushing up the piston is reduced.

Preferably, a limiting ring 19 is fixed on an inner wall of the piston rod sleeve 10, for limiting a position of the piston and preventing the piston from disconnecting with the ring-shaped element 13.

Preferably, the ring-shaped element 13 is made of elastic material.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A piston-type one-way valve, comprising:
a valve body shell;
a valve cover, fixedly connected with said valve body shell via cover bolts;
a valve seat, provided in said valve body shell, wherein said valve seat is in a shape of cylinder, a first side of said valve seat is connected with a medium inlet, a bottom of said valve seat is fixedly connected with said valve body shell, a body chamber is defined by an outer wall of said valve seat and an inner wall of said valve body shell, which is connected with a medium outlet, and said valve seat has an upper opening provided in an upper portion thereof;
a piston, provided in said valve body shell, comprising: a piston head, a piston rod fixedly connected with said piston head, and a sealing gasket fixed on an end surface of said piston head through a piston bolt and an auxiliary fixing gasket, wherein said sealing gasket matches said upper opening of said valve seat in shape, in such a manner that when said piston-type one-way valve is working and said piston is pressed down, said sealing gasket completely covers said upper opening of said valve seat to seal said body chamber and to further prevent medium in said body chamber from flowing back to a seat chamber in said valve seat;
a cylinder convex, provided in a center of said valve cover, wherein a piston rod sleeve in a shape of cylinder is provided in said cylinder convex, said piston rod sleeve matches and sleeves said piston rod, and a round hole is provided in a center of an end surface of said piston rod for matching said piston rod with said piston rod sleeve and reducing a weight of said piston rod;
a spring base, fixed at a first end of said piston rod sleeve, wherein a first end of a spring is fixed on said spring base, a second end of said spring is fixed on said piston head, when the medium flows into said seat chamber from said medium inlet, said piston is pushed up by the medium and said spring is compressed, and when the medium stops flowing into said seat chamber, said piston is tightly pressed upon said upper opening of said valve seat by said spring; and
a ring-shaped element, provided along an opening edge of said valve cover and fixedly connected with said opening edge of said valve cover, wherein an inner circle of said ring-shaped element touches an outer circle of said piston head or said sealing gasket closely, in such a manner that a cover chamber is formed in said valve cover, which is disconnected with said body chamber, medium in said body chamber is not able to enter into said cover chamber, elements in said valve cover is protected from being polluted by the medium, and service lives of said elements are extended.

2. The piston-type one-way valve, as recited in claim 1, wherein a diameter of said upper opening of said valve seat is smaller than a diameter of said sealing gasket, which means that when said piston is pressed down upon said upper opening of said valve seat, a part of said sealing gasket is exposed to said body chamber, in such a manner that medium in said body chamber of some pressure is able to push up said piston by applying a force on said part of said sealing gasket exposed, and flow from said body chamber to said seat chamber, which is for removing impurities sticking on said upper opening of said valve seat or a surface of said sealing gasket.

3. The piston-type one-way valve, as recited in claim 1, wherein an elastic strip is fixed on an edge of said upper opening of said valve seat, for deforming and touching said sealing gasket closely when pressed by said piston.

4. The piston-type one-way valve, as recited in claim 3, wherein an upper surface of said elastic strip is in a shape of arc bending downwards for preventing impurities in the medium staying on said upper surface of said elastic strip.

5. The piston-type one-way valve, as recited in claim 2, wherein an elastic strip is fixed on an edge of said upper opening of said valve seat, for deforming and touching said sealing gasket closely when pressed by said piston.

6. The piston-type one-way valve, as recited in claim 5, wherein an upper surface of said elastic strip is in a shape of arc bending downwards for preventing impurities in the medium staying on said upper surface of said elastic strip.

7. The piston-type one-way valve, as recited in claim 1, wherein an air hole is provided on said valve cover, for connecting said cover chamber with outside, in such a manner that while said piston is going upwards, a part of air in said cover chamber is going out of said valve cover through said air hole, and a force for pushing up said piston is reduced.

8. The piston-type one-way valve, as recited in claim 2, wherein an air hole is provided on said valve cover, for connecting said cover chamber with outside, in such a manner that while said piston is going upwards, a part of air in said cover chamber is going out of said valve cover through said air hole, and a force for pushing up said piston is reduced.

9. The piston-type one-way valve, as recited in claim 3, wherein an air hole is provided on said valve cover, for connecting said cover chamber with outside, in such a manner that while said piston is going upwards, a part of air in said cover chamber is going out of said valve cover through said air hole, and a force for pushing up said piston is reduced.

10. The piston-type one-way valve, as recited in claim 1, wherein a limiting ring is fixed on an inner wall of said piston rod sleeve, for limiting a position of said piston and preventing said piston from disconnecting with said ring-shaped element.

11. The piston-type one-way valve, as recited in claim 2, wherein a limiting ring is fixed on an inner wall of said piston rod sleeve, for limiting a position of said piston and preventing said piston from disconnecting with said ring-shaped element.

12. The piston-type one-way valve, as recited in claim 3, wherein a limiting ring is fixed on an inner wall of said piston rod sleeve, for limiting a position of said piston and preventing said piston from disconnecting with said ring-shaped element.

13. The piston-type one-way valve, as recited in claim 1, wherein said ring-shaped element is made of elastic material.

14. The piston-type one-way valve, as recited in claim 2, wherein said ring-shaped element is made of elastic material.

15. The piston-type one-way valve, as recited in claim 3, wherein said ring-shaped element is made of elastic material.

16. The piston-type one-way valve, as recited in claim 1, wherein an installing screw hole is provided in a bottom center of said valve body shell, for fixing said piston-type one-way valve on a cooling equipment.

17. The piston-type one-way valve, as recited in claim 2, wherein an installing screw hole is provided in a bottom center of said valve body shell, for fixing said piston-type one-way valve on a cooling equipment.

18. The piston-type one-way valve, as recited in claim 3, wherein an installing screw hole is provided in a bottom center of said valve body shell, for fixing said piston-type one-way valve on a cooling equipment.
